(19) United States
(12) Patent Application Publication
(10) Pub. No.: US 2007/0182844 A1
(43) Pub. Date: Aug. 9, 2007

(54) Optical system for producing differently focused images

(75) Inventors: Brendan Edward Allman, East Brunswick (AU); Keith Nugent, North Fitzroy (AU); Colin Porter, Box Hill North (AU)

Correspondence Address: FISH & RICHARDSON PC, P.O. BOX 1022, MINNEAPOLIS, MN, 55440-1022, US

(73) Assignee: Latia Imaging Pty Ltd, Box Hill North (AU)

(21) Appl. No.: 10/598,430

(22) PCT Filed: Feb. 17, 2004
(86) PCT No.: PCT/AU05/00204

§ 371 Date: Aug. 30, 2006

(30) Foreign Application Priority Data
Mar. 9, 2003 (AU) 2004901223

(51) Int. Cl. G03B 13/00

(52) U.S. Cl. 348/345

(57) ABSTRACT

A method and system for producing two differently focused /defocused images is disclosed in which one or more beam splitting means (16, 18) are used to split a beam (14) into a plurality of resultant beams (20, 26, 24) and a plurality of separate sensors (30, 34, 32) are used to detect the beams (20, 26, 24). The path length of the resultant beams (20, 26, 24) to the respective sensors (30, 34, 32) are different for each resultant beam, which can be achieved by placing the sensors (30, 34, 32) at different distances from the respective exit points of the resultant beams (20, 26, 24) from the beam splitting means (16, 18) or by providing optical elements (such as, for instance, movable transparent wedge-shaped members) between the beam splitting means (16, 18) and the sensors 830, 34, 329. A method and system for determining movement of an object by capturing sequential images of the object are also disclosed.

### FIELD OF THE INVENTION

This invention relates to an optical system and method for concurrently producing differently focused images of an object. The invention has particular application in the formation of images required to produce a phase image of the object. The invention may be embodied in a camera for producing a phase image of an object.

### BACKGROUND OF THE INVENTION

The phase image of an object can be calculated from the information contained within a series of intensity images, captured by a camera, of the object. This series of images is usually termed a “through-focal series” due simply to the arrangement of the intensity images at various small distances from the object's in-focus image in the direction of the light's propagation from the object itself. The process by which this calculation is performed is disclosed in International Patent Application No. PCT/AU99/00949 (Publication No. WO 00/26622) owned by The University of Melbourne, and International Patent Application No. PCT/AU02/0001398 owned by the present applicant. The content of these specifications are incorporated in this specification by this reference.

As described in the above patent applications, the method by which this through-focal series is formed is sequential in nature. Namely, the camera mechanism captures each image of the series one after the other with a small displacement in the image sensor's distance relative to the object occurring between each exposure. Since the displacement of the sensor is typically performed by mechanical means, a measurable period of time will elapse between image exposures. For many applications where the object can be considered stationary (or otherwise static), this time lapse is perfectly acceptable. However, there are numerous applications where the subject of interest moves or otherwise changes its physical appearance at a speed sufficiently fast to render the sequential imaging approach unusable. Cases where this can occur are during the observation of growth or other changes in living cells, the isolation of surface structure of moving objects on a production line, tracking atmospheric changes caused by aircraft or identifying and tracking moving camouflaged vehicles and personnel on a battlefield.

Concurrent imaging camera systems are generally available for high quality colour imaging applications. The mechanism by which the images are captured is with a dichroic beam-splitting prism that accepts an input beam of light from a lens assembly. The input beam is then split, by the prism, into three or more beams, each of a different colour, that are directed towards three or more output windows within the prism. At each of the output windows is located an imaging sensor, typically a CCD array, which create individual images of different colours (FIG. 1).

The splitting performed by the prism is typically achieved by several thin film coatings, each of which preferentially reflect a different range of colours. Such coatings are known as dichroic reflectors (FIG. 2). Each of the image sensors are located at precise distances from the prism to ensure that all images are laterally aligned with respect to one another and they are simultaneously in focus.

### SUMMARY OF THE INVENTION

In a first aspect, the present invention provides a system for producing at least two differently focused images of an object, including:
at least two sensors separated from one another;
a beam splitting means for splitting a beam of radiation from the object into at least two resultant beams; and
wherein the path length of the two resultant beams to the respective sensors is different.

Thus, the invention enables the two sensors to produce the through-focal series previously described. This therefore enables the simultaneous capture of two differently focused images of an object.

In the preferred embodiment of the invention, the beam splitting means comprises a prism.

In one embodiment, the prism includes dichroic beam splitting elements which split the beam into at least two beams, each of a different colour.

However, in another embodiment, the prism may include neutral density filters so that the beam is split into the plurality of resultant beams, each of which exhibits no preferential colouration.

The level of light transmission through each of the neutral density filters will depend on the number of sensors being used. Typically for three sensors, a first filter would reflect 33% and transmit 67% of the incident beam, whilst a second filter would transmit and reflect 50% of the beam from the first filter. In this way, each sensor would receive 33% of the original incident beam.

Preferably, the sensors comprise CCD arrays. However, in other embodiments, the sensors could comprise photo diodes or the like. Photo diodes have particular application in environments in which the optical system is used in a confocal microscope which scans across an object in order to produce an image.

The beam of radiation is preferably electromagnetic radiation of any desired wavelength, including infrared, visible light, ultraviolet and X-rays. However, the beam could also be particle radiation, such as an electron beam, and mechanical radiation, such as acoustic waves.

In one embodiment, the sensors are located at different distances from respective exit points of the resultant beams from the beam splitting means to thereby produce the different path lengths. However, in another embodiment, the beam splitting means is longer or shorter in the direction of the respective resultant beam to the respective sensor, and the sensors are attached directly to the beam splitting means to thereby create the different path lengths.

In a still further embodiment, the different path lengths are provided by the location of optical elements between the beam splitting means and the sensors, so as to create a different path length of the resultant beam from the beam splitting means to the respective sensor.

In the preferred embodiment of the invention, the element comprises a pair of transparent wedge-shaped members which are movable relative to one another so as to alter the amount of the wedge through which the resultant beam passes to thereby change the path length of the resultant beam to produce the different path lengths. In this embodiment, the sensors are located at equal distances from the beam splitting means.

In one embodiment of the invention, a beam conditioning element is located between the beam splitting means and the respective sensor.

Preferably, a plurality of beam conditioning elements are locatable between the beam splitting means and the sensors, and moving means is provided for moving the elements, such as to bring one of the elements in turn into registry with the respective sensor so the resultant beam passes through the said one of the elements. In this way, the moving means can move any one of the elements into alignment so as to produce the required conditioning of the beam prior to detection by the sensor.

The conditioning elements may include colour imaging filters, a de-focus wedge system comprised of a pair of transparent wedge elements, and a polariser.

In one embodiment of the invention, the beam comprises an electron beam, and the beam splitting means comprises a plurality of sensors arranged along the direction of the path of the electron beam, and wherein some of the electron beam is detected by a first of the sensors and some of the beam passes through the first of the sensors to a subsequent sensor for detection by that sensor to thereby produce the different path lengths.

In a second aspect, the invention may be said to reside in a system for producing differently focused images of an object, including:
at least two sensors separated from one another;
a beam splitting means for splitting a beam of radiation from the object into at least to resultant beams; and
an optical element located between at least one of the sensors and the beam splitting means in the path of the corresponding resultant beam for changing the path length of the beam from the beam splitting means to the sensor to thereby produce resultant beams having two different path lengths which are detected by the respective sensors.

In the preferred embodiment of the invention, the beam splitting means comprises a prism. In one embodiment, the prism includes dichroic beam splitting elements which split the beam into at least two beams, each of a different colour.

However, in another embodiment, the prism may include neutral density filters so that the beam is split into the plurality of resultant beams, each of which exhibits no preferential colouration.

The level of light transmission through each of the neutral density filters will depend on the number of sensors being used. Typically for three sensors, a first filter would reflect 33% and transmit 67% of the incident beam, whilst a second filter would transmit and reflect 50% of the beam from the first filter. In this way, each sensor would receive 33% of the original incident beam.

Preferably, the sensors comprise CCD arrays. However, in other embodiments, the sensors could comprise photo diodes or the like. Photo diodes have particular application in environments in which the optical system is used in a confocal microscope which scans across an object in order to produce an image.

The beam of radiation is preferably electromagnetic radiation of any desired wavelength, including infrared, visible light, ultraviolet and X-rays. However, the beam could also be particle radiation, such as an electron beam, and mechanical radiation, such as acoustic waves.

In the preferred embodiment of the invention, the element comprises a pair of transparent wedge-shaped members which are movable relative to one another so as to alter the amount of the wedge through which the resultant beam passes to thereby change the path length of the resultant beam to produce the different path lengths. In this embodiment, the sensors are located at equal distances from the beam splitting means.

In one embodiment of the invention, a beam conditioning element is located between the beam splitting means and the respective sensor.

Preferably, a plurality of beam conditioning elements are locatable between the beam splitting means and the sensors, and moving means is provided for moving the elements, such as to bring one of the elements in turn into registry with the respective sensor so the resultant beam passes through the said one of the elements. In this way, the moving means can move any one of the elements into alignment so as to produce the required conditioning of the beam prior to detection by the sensor.

The conditioning elements may include colour imaging filters.

A third aspect of the invention may be said to reside in a system for producing differently focused images of an object, including:
at least two sensors separated from one another;
a beam splitting means for splitting an incoming beam of radiation from the object into at least two resultant beams; and
a beam conditioning member having:
(a) a plurality of beam conditioning elements; and
(b) moving means for moving the member so as to bring the selected one of the elements into alignment with the respective sensor.

In the preferred embodiment of the invention, the beam splitting means comprises a prism. In one embodiment, the prism includes dichroic beam splitting elements which split the beam into at least two beams, each of a different colour.

However, in another embodiment, the prism may include neutral density filters so that the beam is split into the plurality of resultant beams, each of which exhibits no preferential colouration.

The level of light transmission through each of the neutral density filters will depend on the number of sensors being used. Typically for three sensors, a first filter would reflect 33% and transmit 67% of the incident beam, whilst a second filter would transmit and reflect 50% of the beam from the first filter. In this way, each sensor would receive 33% of the original incident beam.

Preferably, the sensors comprise CCD arrays. However, in other embodiments, the sensors could comprise photo diodes or the like. Photo diodes have particular application in environments in which the optical system is used in a confocal microscope which scans across an object in order to produce an image.

The beam of radiation is preferably electromagnetic radiation of any desired wavelength, including infrared, visible light, ultraviolet and X-rays. However, the beam could also be particle radiation, such as an electron beam, and mechanical radiation, such as acoustic waves.

In one embodiment, the sensors are located at different distances from respective exit points of the resultant beams from the beam splitting means to thereby produce the different path lengths. However, in another embodiment, the beam splitting means is longer or shorter in the direction of the respective resultant beam to the respective sensor, and the sensors are attached directly to the beam splitting means to thereby create the different path lengths.

In a still further embodiment, the different path lengths are provided by the location of optical elements between the beam splitting means and the sensors, so as to create a different path length of the resultant beam from the beam splitting means to the respective sensor.

In the preferred embodiment of the invention, the element includes a pair of transparent wedge-shaped members which are movable relative to one another so as to alter the amount of the wedge through which the resultant beam passes to thereby change the path length of the resultant beam to produce the different path lengths.

The conditioning elements may include colour imaging filters and a polariser.

The invention may also be said to reside in a method of producing differently focused images of an object, including:
providing at least two sensors separated from one another;
splitting a beam of radiation emanating from the object into at least two resultant beams; and
causing the path length of the two resultant beams to the respective sensors to be different.

In the preferred embodiment of the inventions referred to above, the differently focused images are comprised of at least one negatively focused image, an in-focus image, and at least one positively focused image. In this embodiment, three sensors are provided and the beam splitting means splits the radiation into three resultant beams, each for detection by one of the sensors.

In a still further aspect of the invention, motion or movement detection is contemplated.

In one embodiment, the system may comprise any of the systems described previously, and the images received by the sensors are time delayed with respect to one another so at least two images which are time delayed are detected by the sensors. These images can then be compared with one another to determine whether there has been any movement of the object to determine motion of the object. The time delay can be provided by taking the images sequentially, rather than concurrently as described above, or producing a time delay by causing one beam to travel along a relatively lengthy path, and another beam to travel along a much shorter path so that the images can be captured concurrently on the different sensors whilst still providing two images which are time delayed for comparison to determine motion. The time delay image can be provided by causing one of the beams to pass through a significant length of optical fibre or the like.

This aspect of the invention may also be said to reside in a system for determining movement of an object, including:
at least one sensor for receiving a beam of radiation from the object and for capturing at least two sequential images of the object which are time delayed with respect to one another;
means for comparing the images with respect to one another so as to determine a difference between the images; and
means for determining whether the object has moved based on the comparison of the images.

Preferably, the images comprise phase images of the object.

Preferably, the comparison is made by the processing means based on a difference between the images.

The comparison of the images and the determination of whether the object has moved may be performed by a single processing means.

In the preferred embodiment of this aspect of the invention, the determination of whether the object has moved is made by creating a phase image of the object from the images which are captured by the sensor and inspecting the phase image to observe light and dark shadows on details in the image, and thereby determining whether the object is moving towards or away from the sensor.

This aspect of the invention may also be said to reside in a method of determining movement of an object, including:
detecting a beam of radiation from the object by a sensor;
producing at least two time delayed images of the object;
comparing the images with respect to one another; and
determining if the object has moved based on a comparison of the images.

### BRIEF DESCRIPTION OF THE DRAWINGS

Preferred embodiments of the invention will be described, by way of example, with reference to the accompanying drawings, in which:

FIG. 1 is a view of an optical system using a conventional camera for producing colour images of an object;

FIG. 2 is showing the transmission curve of dichroic filters used in the embodiment of FIG. 1;

FIG. 3 is a view of a first embodiment of the present invention;

FIG. 4 is a diagram showing the depth of field of the system according to the preferred embodiment of the invention;

FIG. 5 shows the embodiment of FIG. 3, including the sensors;

FIG. 6 shows a further embodiment of the invention;

FIG. 7 shows a still further embodiment of the invention;

FIG. 8 is a still further embodiment of the invention;

FIG. 9 shows yet another embodiment of the invention;

FIG. 10 shows another embodiment of the invention;

FIG. 11 is a view of a still further embodiment of the invention; and

FIG. 12 is a view of a further embodiment of the invention.

### DETAILED DESCRIPTION OF THE PREFERRED EMBODIMENTS

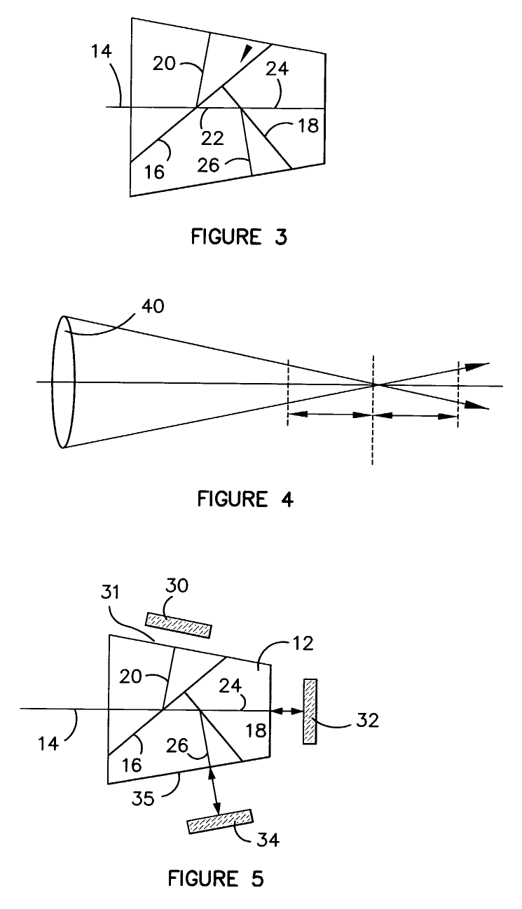

With reference to FIG. 3, the preferred embodiment of the invention includes a prism 12 for receiving a beam of white light 14 from an object to be imaged. The prism 12 includes a first neutral density filter 16 and a second neutral density filter 18. The first filter 16 splits the beam 14 into a first resultant beam 20 and a second beam 22. The beam 20 contains one third of the radiation in the beam 14, and the beam 22 contains two thirds of the radiation in the original beam 14. The second filter 18 then splits the beam 22 into a second resultant beam 24 and a third resultant beam 26. The filter 18 splits the beam 22 so that the beam 24 contains 50% of the radiation in the beam 22, and the beam 26 contains 50% of the radiation in the beam 22. Thus, the resultant beams 20, 24 and 26 contain one third of the original beam 14.

In the preferred embodiment, the optical system shown in FIGS. 3 and 5 is embodied in a camera for producing phase images of an object. Obviously, the camera includes a lens system for focusing the beam 14 from the object which is schematically represented by the lens imaging system 40 in FIG. 4. The camera would also include a processor for producing the calculations in accordance with the algorithm disclosed in the aforesaid International applications to produce the phase images of the object. In order to obtain accurate high resolution phase images, the de-focused images referred to above should be within the depth of field of the imaging system, as shown in FIG. 4 and also mentioned above which, in the preferred embodiment, is 0.08mm either side of the system's focal plane. However, this distance will vary depending on the depth of focus of the lens imaging system.

As shown in FIG. 5, three sensors 30, 32 and 34 are located in the path of the resultant beams 20, 24 and 26 for detecting those beams, as is shown in FIG. 5. FIG. 5 shows that the sensor 32 is at the focal distance of the original beam 14, whereas the sensor 30 is located at the focal distance by an amount of less than 0.08 mm so as to produce a negative de-focused image from the beam 20, and the sensor 34 is located at a distance of up to 0.08 mm greater than the focal distance so as to produce a positive de-focused image from the beam 26.

Thus, according to the embodiment of FIG. 5, the sensors 30 and 34 are located at distances no more than 0.08 mm closer or further from the prism exit face 31 and 35, shown in FIG. 5.

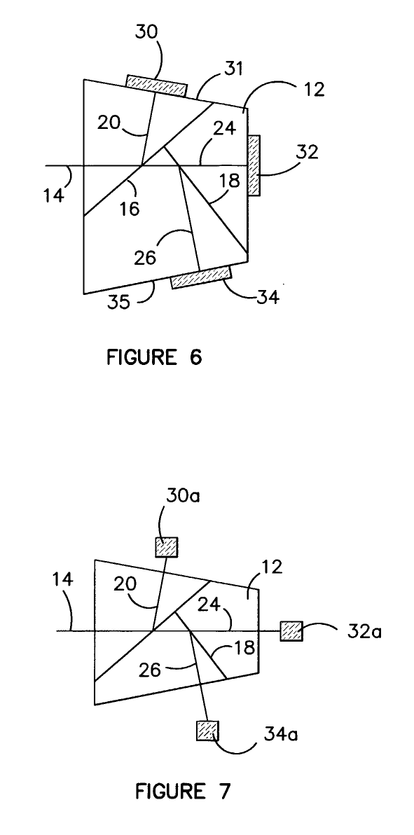

In a second embodiment shown in FIG. 6, the different path length of the resultant beams 20 and 36 to produce the de-focused images, is achieved by making the prism shorter and longer in the direction towards the sensors 30 and 34. As is clearly seen in FIG. 6, the prism is thinner from the incoming beam 14 to the exit face 31, and thicker from the incoming beam 14 to the exit face 35. In this embodiment, the sensors 30, 32 and 34 are adhered directly to the prism 12. This arrangement provides for the different path lengths and also provides greater stability because of the bonding of the sensors 30, 32 and 34 to the respective faces of the prism 12. However, this method can also introduce an aberration called sphero-chromatism, which will lead to degradation in the final phase image that for some applications may be deemed excessive.

In these embodiments, to ensure no time lapse during the capture of the individual images, each of the image sensors must be triggered at precisely the same time. This triggering method is a standard procedure in existing commercially available 3-CCD cameras. However, it should be noted that in some embodiments, as will be explained in more detail, a short delay between the images may be advantageous. These embodiments include the highlighting of turbulent airflow, and also systems which are used for determining movement of an object.

FIG. 7 shows a further embodiment of the invention which is similar to that in FIG. 5, except in this embodiment, the CCD sensors 30, 32 and 34 are replaced by single photo diode-type sensors 30a, 32a and 34a. This arrangement has particular application in confocal scanning microscopes in which the microscope scans over an object in order to produce an image and effectively collects data from discrete points on the object during the scanning process. Hence, only a single photo diode is needed as the sensor rather than the CCD array, as in the earlier embodiments.

It should be noted that this embodiment can also be arranged in the same manner as FIG. 6 with the diodes adhered directly to the prism 12 of the type shown in FIG. 6.

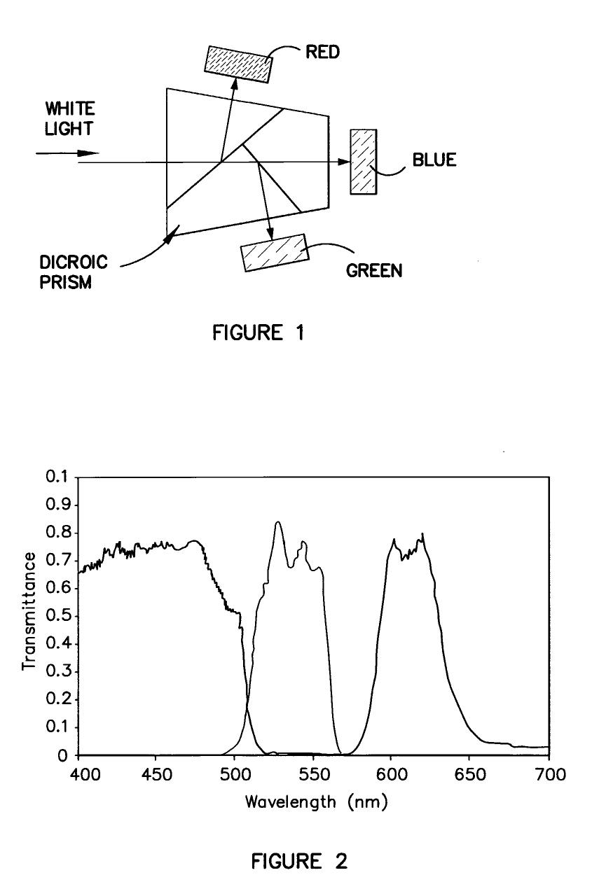

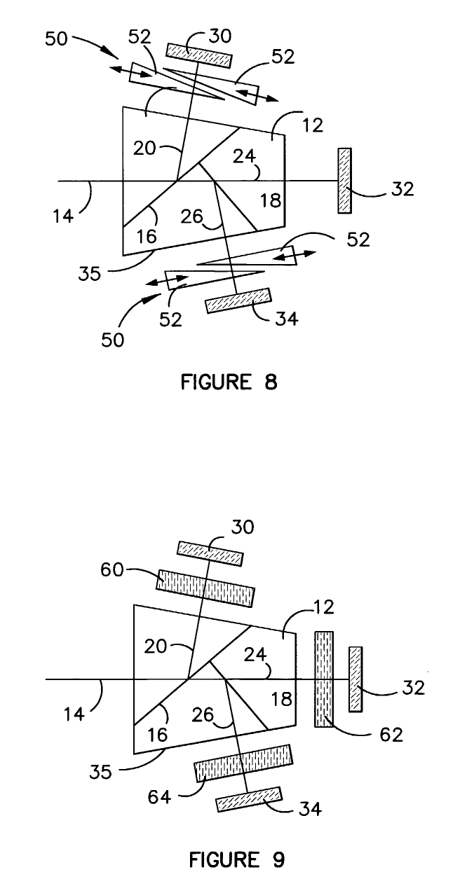

FIG. 8 shows a still further embodiment of the invention, in which the prism and sensors are arranged generally in the same configuration as described with reference to FIG. 1, so that the sensors 30, 32 and 34 are each the same distance from the respective beam splitting filters of the prism 12. In this embodiment, in order to produce the de-focused images at the sensors 30 and 34, a de-focused wedge system 50 is located between the prism 12 and the respective sensors 30 and 34. Each wedge system 50 comprises a wedge 52 formed from a transparent material, such as glass. The wedges are arranged so that their longer inclined surfaces (ie., the hypotenuse surface) face one another. In general, those surfaces would be in contact and the wedges 52 are each mounted for movement relative to one another so as to move the wedges from a position where they completely overlap and effectively form a rectangular block to a position where they are almost completely separated. Thus, this thereby provides a different amount of material through which the beams 20 and 26 must pass before reaching the sensors 30 and 34. This different amount of material, because of diffraction of the light as the light leaves or enters each respective glass wedge, thereby changes the path length of the resultant beams 20 and 26 so as to produce the de-focused images. This embodiment also therefore provides control over the actual path length but appropriate location of the wedges 52 with respect to one another, thereby providing for different magnifications of the lens system of the camera. Thus, this embodiment provides for a continuously adjustable amount of de-focus, and therefore makes the camera system more flexible in its range of applications. The opposing wedges 52 also ensures no beam deviation, regardless of the position of the wedges 52 with respect to one another.

FIG. 9 shows a still further embodiment in which the sensors 30, 32 and 34 are arranged in the same manner described with reference to FIG. 5. In this embodiment, filters 60, 62 and 64 are interposed between the prism and the respective sensors 30, 32 and 34. The filters 60, 62 and 64 can be used to change the basic function of the camera. The filters can provide colour imaging when colour filters are used, or polarisation detection in imaging if polarisers are installed. For colour imaging, the filters need only be simple red, green and blue filters, whereas a polarisation imager would use a linear polariser for filter 60, and a similar but orthogonally oriented polariser for filter 64, filter 62 could be either another differently oriented polariser or a blank sheet of glass to ensure focus is maintained at sensor 32.

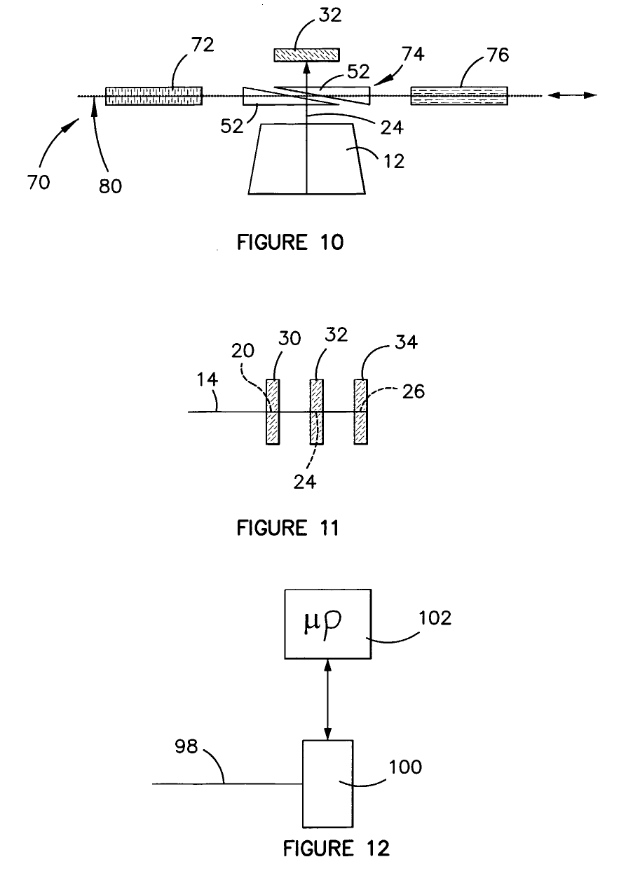

FIG. 10 shows a still further embodiment of the invention. It should be noted that FIG. 10 only shows the sensor 32 for ease of illustration. In this embodiment, an optical member 70 is provided which comprises a plurality of optical conditioning elements 72, 74 and 76. The elements 72, 74 and 76 are located on a moving mechanism schematically represented as 80 which can be any form of translator for eventually moving the filter elements 72, 74 and 76 into alignment with the sensor 32, so the beam 24 passes through a selected one of the elements 72, 74 and 76. In the preferred embodiment of the invention, the element 72 can comprise a colour filter, the element 76 a polariser, and the element 74 a wedge pair formed from two wedges 52, as previously described. Thus, in this embodiment, the effects of the colour filter and polariser which are described above can be obtained by simply moving the translator 80 to bring the appropriate filter into alignment with the sensor 32. If some change in the path length of the beam 24 is also required, the wedge system 74 can be aligned with the sensor 32. The translator can be in the form of a simple mechanical slide or a rotatable wheel. This can be easily accommodated within the camera. however, other moving mechanisms for moving the appropriate element into alignment with the sensor 32 can also be used.

FIG. 11 shows a still further embodiment of the invention, in which electron beams are used to locate the image rather than electromagnetic radiation. In FIG. 11, the incoming beam of electrons 14 is first received by a sensor 30. Sensors 32 and 34 are located behind the sensor 30. Some of the electron beam will be detected by the sensor 30, and other parts of the beam will simply pass through the sensor 30 and be detected by the sensor 32. Similarly, some of the electrons will pass through the sensor 32 and be received by the sensor 34. Thus, the sensors themselves act as the beam splitting element to produce the resultant beams, and the spacing of the sensor 30, 32 and 34 apart produce the different path length to create the focused and de-focused images.

The configuration shown in FIG. 11 could also be used with electromagnetic radiation if the sensors are configured so as to allow part of the beam to pass through the sensors 30 and 32. Typical sensors may be in the nature of film type sensors in which an image is developed. The intensity of the image on the sensors 32 and 34 will obviously be less than that on the previous sensor, and this may need to be taken into account in the processing. The image which is captured by the film sensors could be digitised and used in the same manner as the signal from the CCD sensors or photodiode previously described in order to create the phase image.

In embodiments which use acoustic waves, the beam splitter could be in the form of a member or beam splitter based on a refractive mismatch which provides for amplitude splitting, and the sensors could be ultra sonic transducers.

FIG. 12 shows a still further embodiment of the invention which is concerned with detecting movement or motion of an object. In this embodiment, only one sensor is required. However, the arrangements described with reference to FIGS. 1 to 11 can also be used to determine motion detection, as will be apparent from the following description.

With reference to FIG. 12, a beam of radiation 98 from an object is detected by at least one sensor 100. The sensor 100 captures a first set of in-focus and de-focused images of the object from which a phase image can be created. The in-focus and de-focused images are sequential images rather than concurrent images so that the images which are captured by the sensor are time delayed with respect to one another or, in other words, show the object at different times. Thus, the captured images will be slightly different with respect to one another because of movement of the object, and a comparison of at least two of the captured images can be made to determine whether the object has moved. The determination can be based on a difference between the images. However, in the preferred embodiment of the invention, the captured images are used to create a phase image and the phase image is inspected for light and dark shadows on features of the image indicative of movement of the object relative to the sensor. Thus, the creation of shadows on details in the image enables a determination to be made as to whether the object has moved relative to the sensor and in which direction relative to the sensor. The phase image of course is created in accordance with the algorithm described in the above mentioned International applications. As is noted from FIG. 12, the sensor 100 is connected to a processor 102 in which the phase images are created from the data captured by the sensor 100. The processing to determine movement of the object is also performed in the processor 102, either based on a simple comparison of two of the images captured by the sensor 100 or by creating the phase image and inspecting the phase image for the light and dark shadow regions as referred to above.

Since this technique requires the capture of images which are sequential in time rather than concurrent in time, only a single sensor need be used as is shown in FIG. 12. However, the arrangement shown in FIGS. 1 to 11 could also be used provided that each of the separate sensors is able to capture images of the object which are sequential in time rather than concurrent in time. This can be achieved by simply capturing the image by each sensor at different times rather than concurrently, or introducing an effective time delay of the light beam travelling to one of the sensors compared to the light beam travelling to another sensor so that the light beams effectively contain information relating to the object at different times. In this arrangement, the capturing of the images can be sequential and the fact that the light beams are delayed with respect to one another and effectively show the image at different times enables the determination of motion to be made in the same manner as described above.

Since modifications within the spirit and scope of the invention may readily be effected by persons skilled within the art, it is to be understood that this invention is not limited to the particular embodiment described by way of example hereinabove.

1. A system for producing at least two differently focused images of an object, comprising:
at least two sensors separated from one another;
a beam splitting means for splitting a beam of radiation from the object into at least two resultant beams; and
wherein the path length of the two resultant beams to the respective sensors is different.

2. The system of claim 1 wherein the beam splitting means comprises a prism.

3. The system of claim 2 wherein the prism includes dichroic beam splitting elements which split the beam into at least two beams, each of a different colour.

4. The system of claim 1 wherein the sensors comprise CCD arrays.

5. The system of claim 1 wherein the sensors are located at different distances from respective exit points of the resultant beams from the beam splitting means to thereby produce the different path lengths.

6. The system of claim 1 wherein the different path lengths are provided by the location of optical elements between the beam splitting means and the sensors, so as to create a different path length of the resultant beam from the beam splitting means to the respective sensor.

7. The system of claim 6 wherein the element comprises a pair of transparent wedge-shaped members which are movable relative to one another so as to alter the amount of the wedge through which the resultant beam passes to thereby change the path length of the resultant beam to produce the different path lengths. In this embodiment, the sensors are located at equal distances from the beam splitting means.

8. The system of claim 1 wherein a beam conditioning element is located between the beam splitting means and the respective sensor.

9. The system of claim 8 wherein a plurality of beam conditioning elements are locatable between the beam splitting means and the sensors, and moving means is provided for moving the elements, such as to bring one of the elements in turn into registry with the respective sensor so the resultant beam passes through the said one of the elements.

10. The system of claim 1 wherein the beam comprises an electron beam, and the beam splitting means comprises a plurality of sensors arranged along the direction of the path of the electron beam, and wherein some of the electron beam is detected by a first of the sensors and some of the beam passes through the first of the sensors to a subsequent sensor for detection by that sensor to thereby produce the different path lengths.

11. A system for producing differently focused images of an object, comprising:
at least two sensors separated from one another;
a beam splitting means for splitting a beam of radiation from the object into at least to resultant beams; and
an optical element located between at least one of the sensors and the beam splitting means in the path of the corresponding resultant beam for changing the path length of the beam from the beam splitting means to the sensor to thereby produce resultant beams having two different path lengths which are detected by the respective sensors.

12. The system of claim 11 wherein the beam splitting means comprises a prism.

13. The system of claim 11 wherein the sensors comprise CCD arrays.

14. The system of claim 11 wherein the element comprises a pair of transparent wedge-shaped members which are movable relative to one another so as to alter the amount of the wedge through which the resultant beam passes to thereby change the path length of the resultant beam to produce the different path lengths.

15. The system of claim 14 wherein a beam conditioning element is located between the beam splitting means and the respective sensor.

16. The system of claim 15 wherein a plurality of beam conditioning elements are locatable between the beam splitting means and the sensors, and moving means is provided for moving the elements, such as to bring one of the elements in turn into registry with the respective sensor so the resultant beam passes through the said one of the elements.

17. The system of claim 16 wherein conditioning elements may include colour imaging filters.

18. A system for producing differently focused images of an object, comprising:
at least two sensors separated from one another;
a beam splitting means for splitting an incoming beam of radiation from the object into at least two resultant beams; and
a beam conditioning member having:
(c) a plurality of beam conditioning elements; and
(d) moving means for moving the member so as to bring the selected one of the elements into alignment with the respective sensor.

19. The system of claim 18 wherein the beam splitting means comprises a prism.

20. The system of claim 18 wherein the sensors are located at different distances from respective exit points of the resultant beams from the beam splitting means to thereby produce the different path lengths.

21. The system of claim 18 wherein the different path lengths are provided by the location of optical elements between the beam splitting means and the sensors, so as to create a different path length of the resultant beam from the beam splitting means to the respective sensor.

22. The system of claim 21 wherein the element includes a pair of transparent wedge-shaped members which are movable relative to one another so as to alter the amount of the wedge through which the resultant beam passes to thereby change the path length of the resultant beam to produce the different path lengths.

23. A method of producing differently focused images of an object, including:
providing at least two sensors separated from one another;
splitting a beam of radiation emanating from the object into at least two resultant beams; and
causing the path length of the two resultant beams to the respective sensors to be different.

24. The method of claim 23 wherein the differently focused images are comprised of at least one negatively focused image, an in-focus image, and at least one positively focused image.

25. A system for determining movement of an object, including:
at least one sensor for receiving a beam of radiation from the object and for capturing at least two sequential images of the object which are time delayed with respect to one another;
means for comparing the images with respect to one another so as to determine a difference between the images; and
means for determining whether the object has moved based on the comparison of the images.

26. The system of claim 25 wherein the images comprise phase images of the object.

27. The system of claim 25 wherein the comparison is made by the processing means based on a difference between the images.

28. The system of claim 25 wherein comparison of the images and the determination of whether the object has moved may be performed by a single processing means.

29. The system of claim 28 wherein the determination of whether the object has moved is made by creating a phase image of the object from the images which are captured by the sensor and inspecting the phase image to observe light and dark shadows on details in the image, and thereby determining whether the object is moving towards or away from the sensor.

30. A method of determining movement of an object, including:
detecting a beam of radiation from the object by a sensor;
producing at least two time delayed images of the object;
comparing the images with respect to one another; and
determining if the object has moved based on a comparison of the images.
